(19) United States
(12) Patent Application Publication
(10) Pub. No.: US 2005/0134034 A1
(43) Pub. Date: Jun. 23, 2005

(54) Pyrotechnical drive

(75) Inventor: Franz Wier, Goeggingen (DE)

Correspondence Address: TAROLLI, SUNDHEIM, COVELL & TUMMINO L.L.P., 526 SUPERIOR AVENUE, SUITE 1111, CLEVEVLAND, OH, 44114, US

(73) Assignee: TRW Automotive GmbH

(21) Appl. No.: 10/939,070

(22) Filed: Sep. 10, 2004

(30) Foreign Application Priority Data
Sep. 12, 2003 (DE) 103 42 283.8

(51) Int. Cl. C06D 5/00; B60R 22/00

(52) U.S. Cl. 280/801.1; 102/531

(57) ABSTRACT

In a pyrotechnical drive (110) for a vehicle-occupant restraint system, has a cylinder (112), a piston (114) that is movably arranged in the cylinder, a pyrotechnical propellant charge (152) for generating pressurized gas, and an ignition charge for igniting the propellant charge. The piston has a thrust surface area (142) which can be acted upon with the pressurized gas in order to drive the piston (114). Between the ignition charge and the thrust surface area (142), a flow connection (F) is provided. In addition, a belt retractor (100) is described having a pyrotechnical drive of this type and a method for operating a pyrotechnical drive (110) of this type. In the method, the piston (114) is propelled over a first driving distance (Z1) by the gases generated by the combustion of the ignition charge (154) and is then propelled over a second driving distance by the gases generated during the combustion of the propellant charge (152).

### TECHNICAL FIELD

The invention relates to a pyrotechnical drive for a vehicle-occupant restraining system. The invention also relates to a belt retractor having a drive of this type and to a method for operating a pyrotechnical drive of this type.

### BACKGROUND OF THE INVENTION

A pyrotechnical drive for a vehicle-occupant restraining system has a cylinder, a piston that is movably arranged in the cylinder, a pyrotechnical propellant charge for generating pressurized gas, and an ignition charge for igniting the propellant charge, the piston having a thrust surface area which can be acted upon by the pressurized gas in order to drive the piston.

In FIG. 1, an example of a pyrotechnical drive of this type is illustrated on the basis of a belt tensioner drive from the related art. Belt tensioner drive 10 in FIG. 1 has a cylinder 12, in which a piston 14 is movably guided, and a gas generator 22 for generating pressurized gas to drive piston 14. Gas generator 22 is provided with a propellant charge 52, which is surrounded by a generator housing 70. For igniting propellant charge 52, an ignition charge is provided in the form of a squib 68, which in turn is surrounded by a capsule 58 for protection from humidity and damage. Gas generator 22 is accommodated in the interior space of a recess 40 in piston 14, a wall of the recess that is disposed perpendicular to the direction of movement of the piston constituting a thrust surface area 42. To trigger belt tensioner drive 10, squib 68 is ignited. After capsule 58 bursts, the combustion of propellant charge 52 begins and pressurized gas is generated. When a minimum pressure is reached, generator housing 70 bursts, and the gas pressure can act on thrust surface area 42 of piston 14, setting the latter in motion. Piston 14 is provided with teeth 30, which via a pinion 34 drive the belt reel of a belt tensioner. In FIG. 5, in graph i, the temporal pressure curve on thrust surface area 42 is schematically illustrated. Usually up to 3 ms pass before generator housing 70 bursts. Only then can piston 14 start to move. Because by this time point t₂ high pressure has already built up in generator housing 70, which then abruptly acts upon piston 14, as can be seen from the steep pressure rise in FIG. 5, piston 14 and, after the coupling to the belt tensioner, also teeth 30 and pinion 34 are subjected to high stresses.

The objective of the present invention is to provide a pyrotechnical drive that attains great tensioning power in a short time with reduced component stress.

### BRIEF SUMMARY OF THE INVENTION

For this purpose, a pyrotechnical drive for a vehicle-occupant restraint system, has a cylinder, a piston that is movably arranged in the cylinder, a pyrotechnical propellant charge for generating pressurized gas, and an ignition charge for igniting the propellant charge. The piston has a thrust surface area which can be acted upon with the pressurized gas in order to drive the piston. Between the ignition charge and the thrust surface area, a flow connection is provided. In addition, a belt retractor is described having a pyrotechnical drive of this type and a method for operating a pyrotechnical drive of this type. Thus the pressure generated by the ignition charge can be used for accelerating the piston, so that the piston starts to move already a short time after the ignition. The drive power of the piston is therefore available very early.

In accordance with a second aspect, the present invention provides a belt tensioner that has a pyrotechnical drive of this type. Short time after the ignition, a thrust generated by the ignition charge is made available which is significantly inferior to the thrust generated by the propellant charge. Thus the piston is accelerated initially with smaller force, but in return at a early point in time, and therefore the components in the acceleration phase are only subject to minor stresses. This is especially advantageous when the tensioning drive is coupled to the belt retractor only in the acceleration phase, for example using a teething that engages in a pinion. Then the coupling can be accomplished with smaller stress, whereas the entire power of the propellant charge is made available for the tensioning process.

According to a further aspect, the present invention also provides a method for operating a drive of this type, wherein the piston is propelled over a first driving distance by the gases generated by the combustion of the ignition charge and then is propelled over a second driving distance by the gases generated during the combustion of the propellant charge. This method reduces the stresses on the components and provides a rapid availability of propulsive power. In addition, optimal energy exploitation of both the ignition charge as well as the propellant charge is achieved.

Advantageous embodiments will become apparent in the subclaims.

### BRIEF DESCRIPTION OF THE DRAWINGS

FIG. 1 depicts a longitudinal section of a belt retractor having a belt tensioner drive in accordance with the related art;

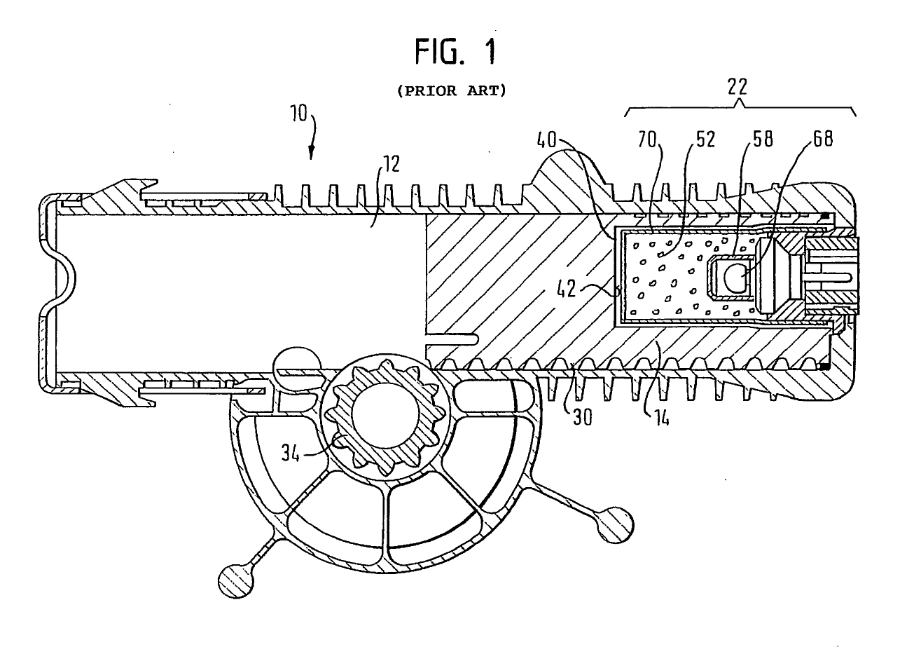

FIG. 2 depicts a longitudinal section of a belt retractor according to the present invention in a first condition;

FIG. 3—FIG. 3 depicts an enlarged representation of section III from FIG. 2;

FIG. 4—FIG. 4 depicts a longitudinal section of a belt retractor from FIG. 2 in a second condition; and

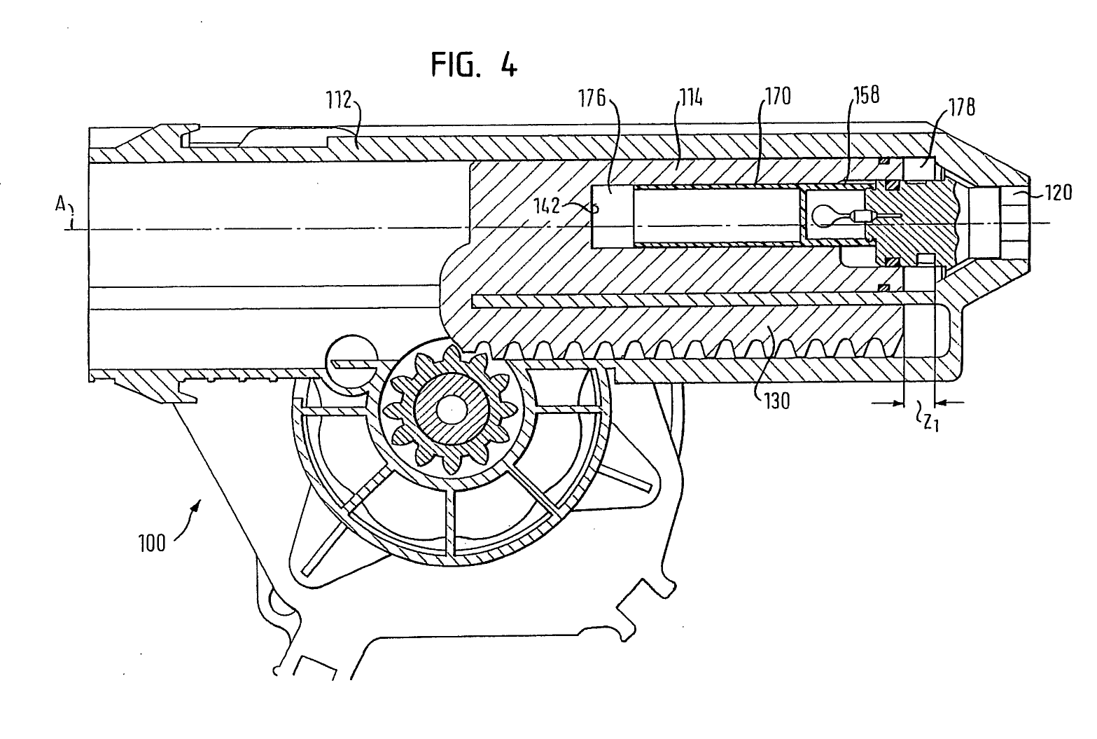

FIG. 5 depicts a schematic comparison of the pressure curve of a pyrotechnical drive according to the related art and a pyrotechnical drive in accordance with the present invention.

### DETAILED DESCRIPTION OF THE PREFERRED EMBODIMENTS

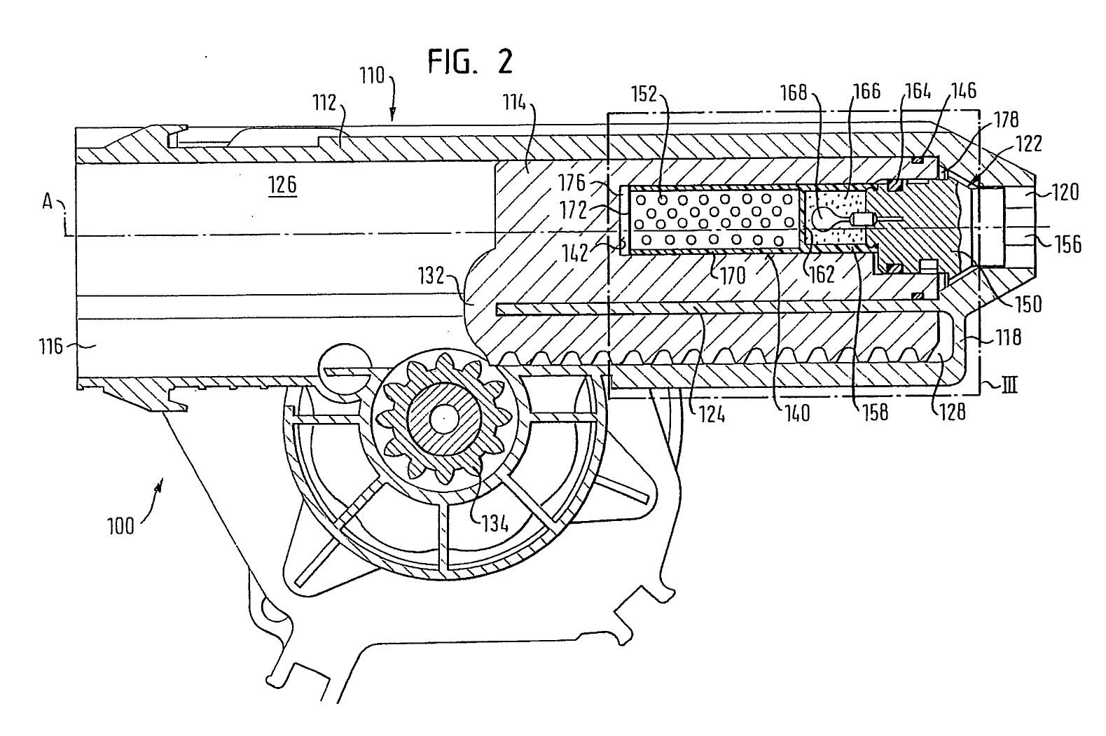

Belt retractor 100 shown in FIG. 2 is equipped with a pyrotechnical drive 110 for tensioning the safety belt. Belt tensioner drive 110 has a cylinder 112 and a piston 114 that can be moved therein along a longitudinal axis A.

Cylinder 112 has a front, open end 116 and a rear end having an end wall 118, in which a receptacle 120 for a gas generator 122 is configured. Cylinder 112 is divided by a separating wall 124 into a piston chamber 126 and a toothed rack chamber 128, separating wall 124 extending from end wall 118 of cylinder 112 parallel to longitudinal axis A roughly to the center of cylinder 112.

Piston 114 is provided with a toothed rack section 130, which is arranged in toothed rack chamber 128 of cylinder 112. Toothed rack section 130 at its front end is connected to piston 114 by a bridge 132, so that when piston 114 is moved, the toothed rack section is carried along with it and can engage in a pinion 134 in order to drive a belt reel of belt retractor 100 in a familiar manner.

Piston 114 is also provided with a generator chamber 140, a cavity which extends into piston 114 from the rear end of piston 114 parallel to longitudinal axis A. At the front end of generator chamber 140, a wall perpendicular to longitudinal axis A forms a thrust surface area 142. In the resting condition of belt tensioner drive 110 depicted in FIG. 2, piston 114 rests on end wall 118 and surrounds gas generator 122, i.e., gas generator 122 is located in generator chamber 140. In addition, on the shell of piston 114 in its rear section there is a seal 146, which contacts the interior shell of piston chamber 126.

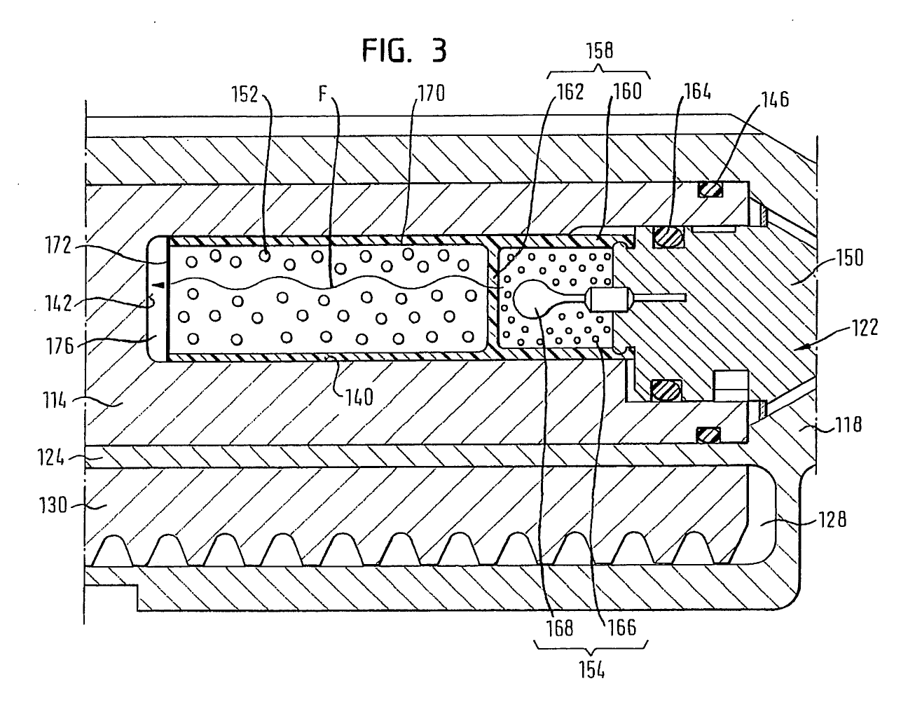

Gas generator 122 has a base 150, via which it sits in receptacle 120 in cylinder 112, a propellant charge 152, and an ignition charge 154. Base 150 is provided with connecting pins 156 for connecting the gas generator, for example, to a control unit. On base 150 sits an ignition charge sleeve 158, which contains the ignition charge 154. Ignition charge sleeve 158 is made up of a pot-like plastic housing that has a casing 160 that is closed by an end wall 162. On the other end, casing 160 is pressed onto base 150, the diameter of base 150 being greater than the diameter of ignition charge sleeve 158. In addition, as can be seen in FIGS. 2 and 3, the cross section of generator chamber 140 is correspondingly configured in steps at the rear end of cylinder 112. At this end, base 150 is also provided with a sealing ring 164, which seals the generator chamber off from piston chamber 126.

Ignition charge 154 is made up of a booster charge 166 and a squib 168, which is located in base 150 and is connected to connecting pins 156.

Axially adjoining the ignition charge sleeve 158, there is a propellant charge sleeve 170, which also has a plastic housing. The housing has a shell, whose rear end adjoins end wall 162 of ignition charge sleeve 158. Propellant charge sleeve 170 contains propellant charge 152, for example, in the form of propellant charge particles. Ignition charge sleeve 158 and propellant charge sleeve 170 are advantageously manufactured in one piece. It is possible, in order to save on material, to reduce the wall thickness of propellant charge sleeve 170, because propellant charge 152 is far less sensitive to mechanical stresses than ignition charge 154.

Ignition charge sleeve 158 and propellant charge sleeve 170, for ignition charge 164 and propellant charge 152, respectively, form a protective sleeve that protects from mechanical damage. Alternatively, they can also be made of other materials, for example, a metal foil. Ignition charge sleeve 158 is permeable to gas at least in the area of end wall 162, so that between ignition charge 154 and thrust surface area 142 there is a flow connection, which is illustrated in FIG. 3 by arrow F.

The ignition charge or the propellant charge, in order to be protected from humidity, can also be enclosed in a foil, for example, one that is made of plastic or metal. In addition, the ignition charge sleeve at its free front side is also closed by a transport safety device 172, also in the form of a foil. When ignition charge 154 is ignited, foil layers located between ignition charge 154 and thrust surface area 142 are destroyed by even a slight pressure, in order to assure flow connection F.

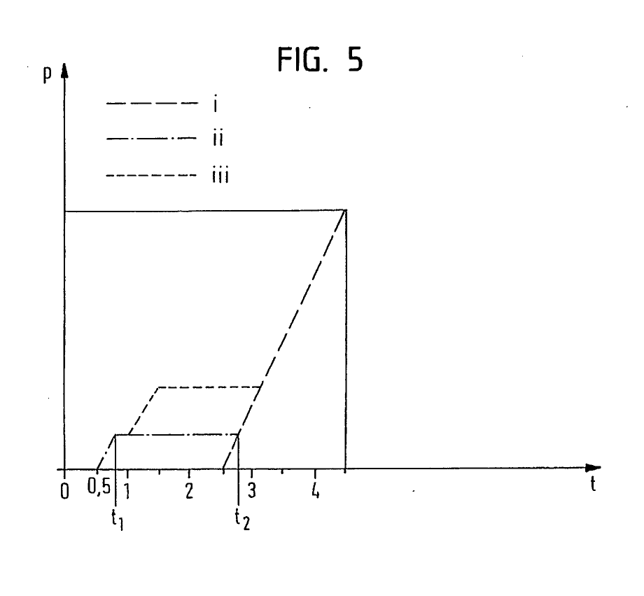

In FIG. 5, the temporal pressure curve of the drive according to the present invention, without booster charge (graph ii) and with booster charge 166 (graph iii), is compared to the pressure curve in a conventional pyrotechnical drive (graph i), as it was described in the introduction.

For triggering belt tensioner drive 110, squib 168 is first ignited. As graph ii of FIG. 5 indicates, as a result of the combustion of squib 168, already at time point t₁, roughly 0.5 ms after the ignition of gas generator 122, a pressure builds up which can exert a thrust on piston 114 on the basis of the flow connection between ignition charge 154 and thrust surface area 142. Therefore, piston 114 starts to move already a short time after the ignition of the ignition charge. After a brief time, booster charge 166, which is ignited by the combustion of squib 168, makes further pressure available, which leads to an increase in the thrust.

Booster charge 166 therefore assures that the inertia of piston 114 and the friction are reliably overcome, and piston 114 is propelled in any case over a first drive path segment Z1 (FIG. 5), until the beginning of toothed rack section 130 engages in pinion 134.

The combustion of ignition charge 154 finally leads to the ignition of the substantially larger propellant charge 152. The latter generates a pressurized gas volume which propels piston 114 with maximum thrust, the motion being transferred to the reel of belt retractor 100 via pinion 134 in order to retract the belt as rapidly as possible in the customary manner.

Since, when piston 114 moves further, base 150 comes out of the expanded section of generator chamber 140, the cross section of piston 114 that is effective for the pressure of the combustion gases expands. If previously, for the reasons cited above, only thrust surface area 142 was available as an effective cross-section for the pressurized gas, then the pressurized gas generated by propellant charge 152 can now act additionally upon a further thrust surface area 176 at the rear end of piston 114, so that the entire effective thrust surface area corresponds to the cross-section of piston 114 perpendicular to its direction of motion along longitudinal axis A. Thus an increased thrust is made available for the further motion of piston 114 and therefore ultimately for tensioning a safety belt.

As long as toothed rack section 130 has not yet engaged in pinion 134, only a small thrust is required, because the reel of belt retractor 100 does not yet have to be driven. Therefore, thrust surface area 142 is advantageously selected so as to be so large that it occupies a maximum of 30% of the entire piston cross-sectional surface. This has the advantage that piston 114 can be propelled over a sufficient distance even using the slight pressurized gas volume that is generated by ignition charge 154.

By selecting an appropriate shape of the particles of propellant charge 154 and by minimizing the clearance volume 178 between propellant charge sleeve 170 and thrust surface area 142, the dead volume can be minimized so as to be able to optimally exploit the gas pressure from ignition charge 154. If the thrust of squib 168 is sufficient, it is even possible to do without booster charge 166.

A further advantage of the drive according to the present invention lies in the fact that as a result of the initially small thrust that is produced by the ignition charge, the components, especially the first teeth of toothed rack section 130 and of pinion 134, are only exposed to slight stresses. To further improve the meshing of toothed rack section 130 into pinion 134, the first tooth of toothed rack section 130 is shortened by roughly 50%. Therefore, piston 114 in its resting position can also be arranged so as to be closer to pinion 134, resulting in a smaller overall length of drive 110.

Furthermore, as a result of the propulsion of piston 114 over first drive path segment Z1, the combustion chamber for propellant charge 152 is expanded, because clearance volume 178 is expanded (see FIG. 5). On the other hand, as was described above, the cross-section of thrust surface area 142 amounts to only a fraction of the overall cross-section of piston 114, which assures that the combustion chamber in the first propulsion phase of piston 114 does not expand excessively. An optimized expansion is advantageous for the complete combustion of propellant charge 152 and thereby aids the optimal exploitation of the energy contained in propellant charge 152.

According to an alternative embodiment, the propellant charge, in order to save material and weight, can also be placed directly in the generator chamber, so that only the ignition charge is surrounded by a protective sleeve.

The tensioner drive according to the present invention and the method are illustrated by way of example on the basis of a belt retractor. However, they are suitable for all applications in which high retraction power must be achieved, such as a buckle and fitting retractor or hood collision protection system.

1. A pyrotechnical drive for a vehicle-occupant restraint system, comprising a cylinder, a piston that is movably arranged in said cylinder, a pyrotechnical propellant charge for generating pressurized gas, and an ignition charge for igniting said propellant charge, said piston having a thrust surface area which can be acted upon with said pressurized gas in order to drive said piston, wherein a flow connection is provided between said ignition charge and said thrust surface area.

2. The pyrotechnical drive as recited in claim 1, wherein said ignition charge is accommodated in a protective sleeve, which is at least partially permeable to gas, in order to enable a flow connection.

3. The pyrotechnical drive as recited in claim 1, wherein said ignition charge is provided with a booster charge.

4. The pyrotechnical drive as recited in claim 1, wherein said piston has a generator chamber, in which said propellant charge is accommodated.

5. The pyrotechnical drive as recited in claim 1, wherein said propellant charge is accommodated in a protective sleeve, which is at least partially permeable to gas, in order to enable a flow connection.

6. The pyrotechnical drive as recited in claim 2, wherein said protective sleeve is a metallic foil sleeve.

7. The pyrotechnical drive as recited in claim 5, wherein said protective sleeve is a metallic foil sleeve.

8. The pyrotechnical drive as recited in claim 2, wherein said at least one protective sleeve is a plastic housing.

9. The pyrotechnical drive as recited in claim 1, wherein said piston and said generator chamber each have a cross-sectional area transverse to said moving direction of said piston, said cross-sectional area of said generator chamber being a maximum of 20% of said cross-sectional area of said piston.

10. The pyrotechnical drive as recited in claim 1, wherein between said ignition charge and said thrust surface area a humidity protective foil is provided, which is destroyed in response to the ignition of the ignition charge, in order to permit a flow connection.

11. A belt retractor having a pyrotechnical drive for a vehicle-occupant restraint system, said pyrotechnical drive comprising a cylinder, a piston that is movably arranged in said cylinder, a pyrotechnical propellant charge for generating pressurized gas, and an ignition charge for igniting said propellant charge, said piston having a thrust surface area which can be acted upon with said pressurized gas in order to drive said piston, wherein a flow connection is provided between said ignition charge and said thrust surface area.

12. A method for operating a pyrotechnical drive as recited in claim 1, wherein said piston is propelled over a first driving distance by gases generated by combustion of said ignition charge and is then propelled over a second driving distance by gases generated during combustion of said propellant charge.

13. The method as recited in claim 11, wherein combustion of said ignition charge generates gases under pressure which produce a first thrust, wherein combustion of said propellant charge generates gases under pressure which produce a second thrust and wherein said first thrust is inferior to said second thrust.

14. The method as recited in claim 12, wherein said first inferior thrust is achieved in that said pressure of said gases generated by combustion of said ignition charge act upon a thrust surface area which corresponds to only one part of said cross-sectional surface of the piston.
